(19) United States
(12) Patent Application Publication
(10) Pub. No.: US 2009/0297936 A1
(43) Pub. Date: Dec. 3, 2009

(54) Assembled battery formed by stacking a plurality of flat cells

(76) Inventors: Seiji Nemoto, Kyoto (JP); Tomotada Mochizuki, Kyoto (JP); Takeshi Shimozomo, Kyoto (JP); Isao Suzuki, Kyoto (JP); Noriyoshi Munenaga, Kyoto (JP); Minoru Hirata, Kyoto (JP); Takeshi Nakamoto, Kyoto (JP); Shun Ito, Kyoto (JP)

Correspondence Address: CARRIER BLACKMAN AND ASSOCIATES, 43440 WEST TEN MILE ROAD, EATON CENTER, NOVI, MI, 48375, US

(21) Appl. No.: 12/309,168

(22) PCT Filed: Jul. 13, 2007
(86) PCT No.: PCT/JP2007/063962

§ 371 Date: Jan. 9, 2009

(30) Foreign Application Priority Data
Jul. 13, 2006 (JP) 2006-193275

(51) Int. Cl. H01M 6/46

(52) U.S. Cl. 429/152

(57) ABSTRACT

There is provided an assembled battery in which a plurality of flat cells having battery containers using a flexible film are vertically stacked by opposing the flat surfaces to each other. The assembled battery has a spacer disposed between the adjacent cells.

### TECHNICAL FIELD

The present invention relates to an assembled battery formed by stacking a plurality of flat cells having battery containers using a flexible film.

### BACKGROUND ART

FIG. 11 shows a configuration example of a conventional flat type nonaqueous electrolyte secondary battery 1 having a battery container using an aluminum laminate film.

The aluminum laminate film is a film obtained by forming a resin layer on at least one side of an aluminum foil. Unlike a hard material such as an aluminum plate, an iron plate, a nickel plate, or the like to be used for a metal can for a cylindrical or prismatic battery case, this aluminum laminate film is easily sagged by applying slight force and accordingly one kind of so-called flexible films.

This nonaqueous electrolyte secondary battery 1 contains a flat power generating element (power storage element) 12 housed in a battery container composed of two square aluminum laminate films 11. These two aluminum laminate films 11 sandwiches the power generating element 12 from upper and lower sides. At that time, the two aluminum laminate films 11 are overlapped and thermally fusion-bonded in the outer rim sides of the front and rear end parts 1a and right and left side end parts 1b to closely seal the inside. Accordingly, with respect to the nonaqueous electrolyte secondary battery 1, the square shape is formed by the four sides; front and rear and right and left. The nonaqueous electrolyte secondary battery 1 has a flat shape sufficiently thin in the vertical thickness as compared with the length of these four sides. Further, flat faces 1c as shown in FIG. 11 are formed in the outer faces of the two aluminum laminate films 11 sandwiching the power generating element 12.

With respect to the above-mentioned nonaqueous electrolyte secondary battery (cell) 1, a plurality of such cells are sometimes assembled to give an assembled battery. In this case, conventionally, it is common that cells are stacked by sticking the flat faces 1c to one another directly or using a double-sided adhesive tape.

In such a conventional assembled battery, nonaqueous electrolyte secondary cells 1 are stacked by tightly sticking the flat faces 1c very close to the power generating elements 12, heat generating sources, and have wide surface areas. Accordingly, the flat faces 1c tightly stuck one another cannot sufficiently release heat although the surface areas are wide. As a result, the battery temperature becomes so high due to heat generation along with charging and discharging that a problem of shortening the battery life could be caused. Particularly, in a nonaqueous electrolyte secondary cell 1 installed in the middle to arrange other cells in both upper and lower sides, heat can be released only from the right and left side end parts 1b and the end parts 1a. Consequently, the problem of insufficient heat release is especially serious.

Further, in this assembled battery, vibrations and impacts are easily transmitted directly to the respective nonaqueous electrolyte secondary cells 1 from the outside. As a result, there occurs a problem that the aluminum laminate films 11, which are flexible and weak in strength, are easily damaged.

In addition, conventionally, inventions of promoting heat release by arranging a plurality of the nonaqueous electrolyte secondary cells 1 of an assembled battery in the right and left directions in FIG. 11 have been developed (e.g. Japanese Patent Application Laid-Open (JP-A) No. 2005-108750). However, such an assembled battery becomes too wide in the width of the right and left directions and therefore, there occurs a problem that the assembled battery cannot be housed in a limited narrow space.

Patent Document 1: JP-A No. 2005-108750

### DISCLOSURE OF THE INVENTION

### Problems to be Solved by the Invention

The present invention provides an assembled battery in which heat release of cells is promoted and flexible films are hardly damaged by vibrations and impacts by disposing spacers among a plurality of stacked cells.

### Means for Solving the Problems

The first invention according to the present invention is an assembled battery in which a plurality of flat cells having battery containers using a flexible film are vertically stacked by opposing the flat faces to one another and spacers are disposed between the neighboring cells.

The second invention according to the present invention is the assembled battery of the first invention in which the spacers are each composed of two or more parts arranged at interval so as to keep gaps between the flat faces of the neighboring cells.

The third invention according to the present invention is the assembled battery of the first invention in which the spacers are each composed of parts for supporting side end parts in the right and left of the cells so as to keep gaps between the flat faces of the neighboring cells.

The fourth invention according to the present invention is the assembled battery of the first invention in which the spacers are parts to be arranged from the left side end parts to flat faces of neighboring cells and further to the right side end parts and have a thickness thicker between the left side end parts and between the right side end parts than between the flat faces.

The fifth invention according to the present invention is the assembled battery of the first invention in which the spacers are each provided with guide parts in at least one position of the front and the rear of the neighboring cells for inducing air blow and the guide parts are formed so as to induce air blow along the side end parts of the cells.

The sixth invention according to the present invention is the assembled battery of the fourth invention in which the spacers each have holes between the left side end parts and/or between the right side end parts of neighboring cells.

The seventh invention according to the present invention is the assembled battery of the sixth invention in which the holes penetrate the spacers in the front and rear direction.

The eighth invention according to the present invention is the assembled battery of the first invention in which the spacers are elastic bodies.

The ninth invention according to the present invention is the assembled battery of the third invention in which the spacers are elastic bodies having spring elasticity.

The tenth invention according to the present invention is the assembled battery of the first invention in which the spacers each contain at least a shockproof material for buffering an impact from the outside and a material having higher heat conductivity than that of the shockproof material.

The eleventh invention according to the present invention is the assembled battery of the tenth invention in which the material having higher heat conductivity contains at least one material selected from the group consisting of carbon and metals.

According to the first invention of the present invention, since the spacer is disposed between the stacked cells, a gap can be kept between the wide flat faces of these cells or circulation of flow of air etc. in the gaps between the right and left side end parts can be promoted, and thus, heat release of the battery can be promoted. Further, since vibrations and impacts can be moderated by the spacer between the respective cells, the flexible films used in the battery containers of these cells can be prevented from damages. Particularly, if an elastic body is used for the spacer, the effect of buffering vibrations and impacts can be improved further.

According to the second invention of the present invention, since the spacers are each composed of two or more parts arranged at intervals so as to generate gaps between the flat faces of the neighboring cells, the gaps are kept reliably between these spacers to promote heat release.

According to the third invention of the present invention since the spacers are each composed of parts for supporting side end parts in the right and left of the cells so as to keep gaps between the flat faces of the neighboring cells, there is nothing which interferes circulation of air or the like between the wide flat faces and thus heat release of cells can further be promoted.

According to the fourth invention of the present invention, with respect to the assembled battery of the first invention, since the spacers are parts to be arranged from the left side end parts to flat faces of neighboring cells and further to the right side end parts and have a thickness thicker between the left side end parts and between the right side end parts than between the flat faces, the position displacement of the cells due vibration and impacts can be prevented. Moreover, if elastic bodies are used as the spacers, the effect of buffering vibrations and impacts can be improved. Further, if R is formed in the edge parts of these spacers, damages of the flexible films can further be reliably prevented. Furthermore, if flow channels such as holes, slits or the like are formed in the spacers, heat release of the cells can be promoted by promoting air circulation. Particularly, in the case where projections or recessed parts or grooves extended in the front and rear direction are formed in the flat faces of the spacers, air flow channels are formed between the flat faces and therefore, an excellent heat release effect can be exerted.

According to the fifth invention of the present invention, the spacers are each provided with guide parts in at least one position of the front and the rear of the neighboring cells for inducing air blow and the guide parts are formed so as to induce air blow along the side end parts of the cells. Consequently, due to the existence of the guide parts, the air blow flowing in the side end parts of the cells can be made strong and thus an effect of more efficiently cooling the cells can be exerted.

According to the sixth invention of the present invention, the spacers each have holes between the left side end parts and/or between the right side end parts of neighboring cells (e.g. FIG. 6). Formation of the holes as described above improves the cushion property (impact-buffering property) of the parts of the spacers positioned between the side end parts of the cells. Consequently, an assembled battery excellent in the impact resistance can be obtained.

According to the seventh invention of the present invention, with respect to the sixth invention, since the holes penetrate the spacers in the front and rear direction, air flows in the holes and thus an effect of improving the heat releasing property of an assembled battery can be exerted.

According to the eighth invention of the present invention, since the spacers are elastic bodies, an assembled battery hardly damaged by vibrations and impacts can be obtained.

According to the tenth invention of the present invention, the spacers each contain at least a shockproof material for buffering an impact from the outside and a material having higher heat conductivity than that of the shockproof material. Consequently, owing to the function of the shockproof material, an assembled battery hardly damaged by vibrations and impacts can be obtained. Further, owing to the function of the material having the higher heat conductivity, an assembled battery excellent in heat releasing property can be obtained.

The up and down, right and left, and back and forth directions in this specification are only for convenience to show orthogonally crossing three-dimensional directions and these directions can arbitrarily be changed. That is, practically, the configuration becomes the same even if the top and the bottom are changed and the top and bottom and the right and left are changed. For example, if the top (upper part) and bottom (lower part) of claims are replaced with the actual right and left and the right and left of claims are replaced with the actual top (upper part) and bottom (lower part), an assembled battery formed by transversely stacking a plurality of cells can actually be obtained and such an assembled battery is considered to be equivalent to the “assembled battery in which a plurality of flat cells having battery containers using a flexible film are vertically stacked by opposing the flat faces to one another”. In drawings, the projected directions of the leads are in the front and rear directions; however, the leads may be projected in the directions other than the front and rear directions. The up and down directions of the cells are directions orthogonally crossing the flat faces. However, the distinction of the front and rear directions of the cells and the right and left directions is only for convenience and there is actually no distinction.

### BRIEF DESCRIPTION OF THE DRAWINGS

FIG. 1 is a perspective view of an assembly of two upper and lower nonaqueous electrolyte secondary cells and a spacer disposed between the cells, showing Example 1 of the present invention.

FIG. 2 is a perspective view of an assembly of stacked nonaqueous electrolyte secondary cells and a spacer disposed between the cells, showing Example 1 of the present invention.

FIG. 3 is a perspective view of an assembly of two upper and lower nonaqueous electrolyte secondary cells and a spacer disposed between the cells, showing another configuration example of Example 1 of the present invention.

FIG. 4 is a perspective view of an assembly of two upper and lower nonaqueous electrolyte secondary cells and a spacer disposed between the cells, showing Example 2 of the present invention.

FIG. 5 is a perspective view of an assembly of stacked nonaqueous electrolyte secondary cells and a spacer disposed between the cells, showing Example 2 of the present invention.

FIG. 6 is a perspective view of an assembly of two upper and lower nonaqueous electrolyte secondary cells and a spacer disposed between the cells, showing Example 3 of the present invention.

FIG. 7 is a perspective view of an assembly of stacked nonaqueous electrolyte secondary cells and a spacer disposed between the cells, showing Example 3 of the present invention.

FIG. 8 is a front view of an assembly of stacked nonaqueous electrolyte secondary cells and a spacer disposed between the cells, showing another configuration example of Example 3 of the present invention.

FIG. 9 is a perspective view of an assembly of two upper and lower nonaqueous electrolyte secondary cells and a spacer disposed between the cells, showing Example 4 of the present invention.

FIG. 10 is a perspective view of an assembly of stacked nonaqueous electrolyte secondary cells and a spacer disposed between the cells, showing Example 4 of the present invention.

FIG. 11 is a perspective view showing an assembly with configuration of a nonaqueous electrolyte secondary battery.

### EXPLANATION OF SYMBOLS

1. Nonaqueous electrolyte secondary battery (cell)
1a. End part
1b. Side end part
1c. Flat face
11. Aluminum laminate film
12. Power generating element
13. Lead terminal
2. Spacer
3. Spacer
4. Spacer
4a. Upper support part
4b. Lower support part
5. Spacer
5a. Battery support part
5b. Triangular hole
6. Spacer
6a. Battery support part
7. Spacer
7a. End part support part
7b. Guide plates

### BEST MODE FOR CARRYING OUT THE INVENTION

Hereinafter, the best mode of an embodiment of the present invention will be described.

In the embodiment, an assembled battery formed by stacking up and down a plurality of nonaqueous electrolyte secondary cells 1 same as shown in FIG. 11 will be described. Each of the nonaqueous electrolyte secondary cells 1 comprises a flat power generating element 12 housed in a battery container composed of two square aluminum laminate films 11.

As the aluminum laminate films 11 are employed square flexible films with a three-layer structure formed by layering a resin layer of such as nylon and PET (poly(ethylene terephthalate)) having high barrier property and strength in one face of an aluminum foil and layering a thermoplastic resin layer of such as polypropylene, polyethylene or the like on the other face. Further, these aluminum laminate films 11 have recessed dent parts in large parts of the centers in the thermoplastic resin layer side to fix the flat type power generating element 12.

The power generating element 12 is formed into a flat, long, and cylindrical shape by rolling strip-form positive electrode and negative electrode while inserting a separator between the electrodes and each one lead terminal 13 for the positive electrode and negative electrode are extruded out of both front and rear end faces. However, this power generating element 12 is not necessarily limited to the long and cylindrical rolled type one if it has a flat shape thin in the thickness in the up and down direction as compared with the length in the front and rear direction or the right and left directions and for example it may be stacked type one. Further, the lead terminals 13 are also not necessarily limited in the type that they are extruded each from the front and rear end faces of the power generating element 12 and the lead terminals 13 of the positive electrode and negative electrode may be extruded out of only the front end face.

The above-mentioned two aluminum laminate films 11 are set in a manner that the thermoplastic resin layers are placed face to face and the power generating element 12 is fitted in the inside space formed by the dent parts. At that time, the outer rim sides of the front and rear end parts 1a and the right and left side end parts 1b are overlapped and thermally fusion-bonded to form a battery container whose inside is tightly closed. At that time, the respective lead terminals 13 extruded out of the end faces of the power generating element 12 are to be extruded outside through gaps of the thermally fusion-bonded parts of the aluminum laminate films 11 in the outer rim sides of the front and rear end parts 1a. Further, an electrolyte solution is filled in the space where the power generating element 12 is housed before the aluminum laminate films 11 are completely tightly closed in the outer rim sides of the front and rear end parts 1a and the outer rim sides of the right and left side end parts 1b by the thermal fusion-bonding.

The nonaqueous electrolyte secondary cells 1 with the above-described configuration has an approximately square shape formed by four front, rear, right and left sides and is sufficiently thin in the thickness in the up and down direction as compared with these four side length. In these four sides, the ratio of the cell thickness in the up and down direction to the length shorter among the four sides in the front and rear direction and the right and left directions is preferably 0.01 to 0.4 and more preferably 0.03 to 0.25. The outer faces of the dent parts of the two aluminum laminate films 11 are approximately wide and flat faces projected up and down to form the flat faces 1c of the nonaqueous electrolyte secondary cells 1.

In this embodiment, each nonaqueous electrolyte secondary cell 1 having a battery container composed of the two aluminum laminate films 11 is shown; however, the configuration of the aluminum laminate films 11 is arbitrary and for example the dent part may be formed only one aluminum laminate film 11 and only aluminum laminate films 11 having no dent part at ally may be used. Further, one aluminum laminate film 11 may be folded to compose the battery container. Furthermore, a metal-resin laminate film using another metal layer having barrier property in place of the aluminum foil of the aluminum laminate film 11 may be used. Moreover, if the film is a flexible film capable of reliably retaining sufficient strength and barrier property and reliably sealable, any material is usable and for example, a laminate film made of resin alone or a single material film, which is not a laminate, can be used.

The assembled battery of the present embodiment is formed by vertically stacking a plurality of the above-mentioned nonaqueous electrolyte secondary cells 1 by opposing the flat faces 1c to one another. Further, spacers are disposed between the vertically neighboring cells 1. The spacers may be so-called solid bodies with filled inside or such solid bodies having holes or slits formed therein or frame bodies having a structure formed by bending or bonding plate materials and rod materials. The spacers are preferably those which exhibit elasticity to a certain extent, such as solid bodies made of a rubber or frame bodies made of resins.

Further, that the spacers are disposed between neighboring nonaqueous electrolyte secondary cells means that the spacers are disposed between the opposed flat faces 1c of neighboring nonaqueous electrolyte secondary cells 1 or spacers are disposed between the flat faces 1c and between the side end parts 1b (at least one of the right and left) and between the end parts 1a (at least one of the front and rear) while keeping a gap between the flat faces 1c. The case that the spacers are disposed in at least one between the side end parts 1b (at least one of the right and left) and between the end parts 1a (at least one of the front and rear) without keeping a gap between the flat faces 1c is also included.

With respect to the assembled battery, in the case where all of the nonaqueous electrolyte secondary cells 1 are connected in series, the lead terminal 13 of the positive electrode of one of neighboring nonaqueous electrolyte secondary cells 1 and the lead terminal 13 of negative electrode of the other neighboring nonaqueous electrolyte secondary cells 1 are mutually overlapped and connected by welding or the like. Thereafter, these stacked nonaqueous electrolyte secondary cells 1 are generally housed in a box-form assembled battery case. The assembled battery case keeps the stacked state of a plurality of the nonaqueous electrolyte secondary cells 1 and at the same time protects the aluminum laminate films 11 with relatively weak strength in the respective nonaqueous electrolyte secondary cells 1. Further, the assembled battery has a proper number of ventilation holes for circulating outer air in the inside. The ventilation holes may be formed to generate spontaneous outer air circulation but also to forcibly generate the air circulation by a ventilator.

With the above-mentioned configuration, since spacers are arranged between the stacked nonaqueous electrolyte secondary cells 1, the structure formed has a gap between a wide flat faces 1c of these nonaqueous electrolyte secondary cells 1 and thus a large quantity of air can be circulated in the gap. Further, even in the case where there is no gap between the flat faces 1c, the formed structure can circulate air in the gap between right and left side end parts 1b. Accordingly, owing to this air flow, heat release can be promoted in the stacked nonaqueous electrolyte secondary cells 1 not only in the case that the spacers are disposed in the up end down end but also in the case where the spacers are arranged in the center parts and thus the temperature difference can be suppressed.

Further, since vibrations and impacts from the outside can be buffered by the spacers between the respective nonaqueous electrolyte secondary cells 1, the aluminum laminate films 11 of these nonaqueous electrolyte secondary cells 1 can be prevented from damages. Particularly, if elastic bodies are used as the spacers, the buffering effect on vibrations and impacts can further be improved.

In the present invention, the spacers may contain a shockproof material for buffering an impact from the outside and a material having higher heat conductivity than that of the shockproof material. By doing so, an assembled battery hardly damaged by vibrations and impacts can be obtained owing to the function of the shockproof material. Further, owing to the function of the material having the higher heat conductivity, an assembled battery excellent in heat releasing property can be obtained. As the material having high heat conductivity, carbon and metals can be exemplified. These carbon and metals are particularly preferable to be mixed in the spacers in form of powders.

In the above-described embodiment, the case that the cooling is carried out by air circulation in the gap between the flat faces 1c of the nonaqueous electrolyte secondary cells 1 is described; however, cooling of the nonaqueous electrolyte secondary cells 1 can be carried out by circulating any arbitrary fluid in place of air.

As described above, the case that the assembled battery comprises nonaqueous electrolyte secondary cells as cells is mainly described for explaining the present invention. However, it is no need to say that the cells of the present invention are not limited to the nonaqueous electrolyte secondary cells from a viewpoint of the principle of the present invention. The cells to be used in the present invention may be lead acid batteries, nickel-cadmium batteries, nickel metal hydride batteries, and various types of primary batteries.

### EXAMPLES

### Example 1

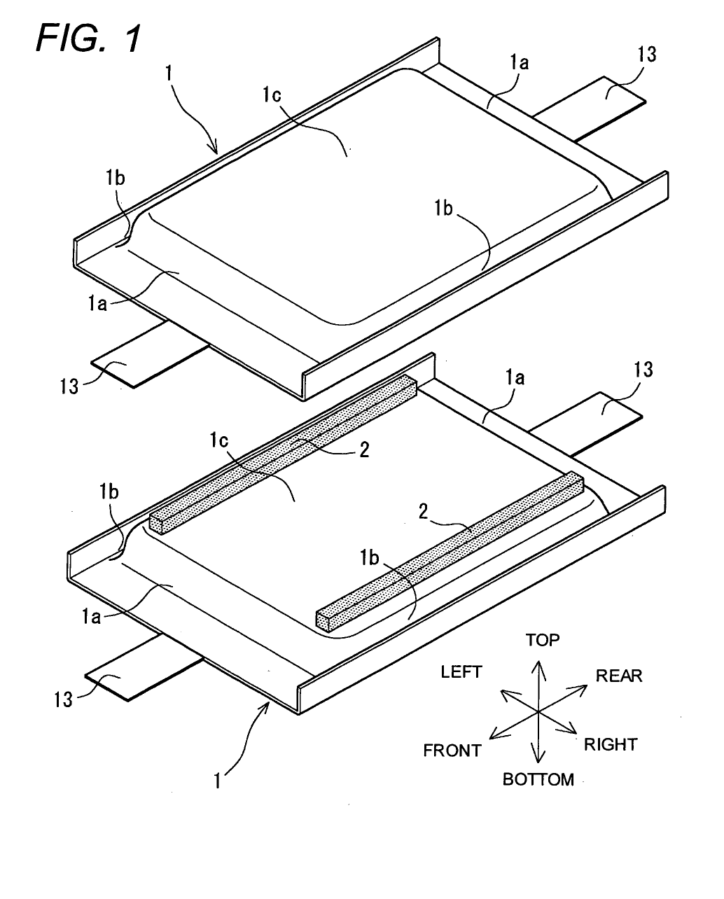

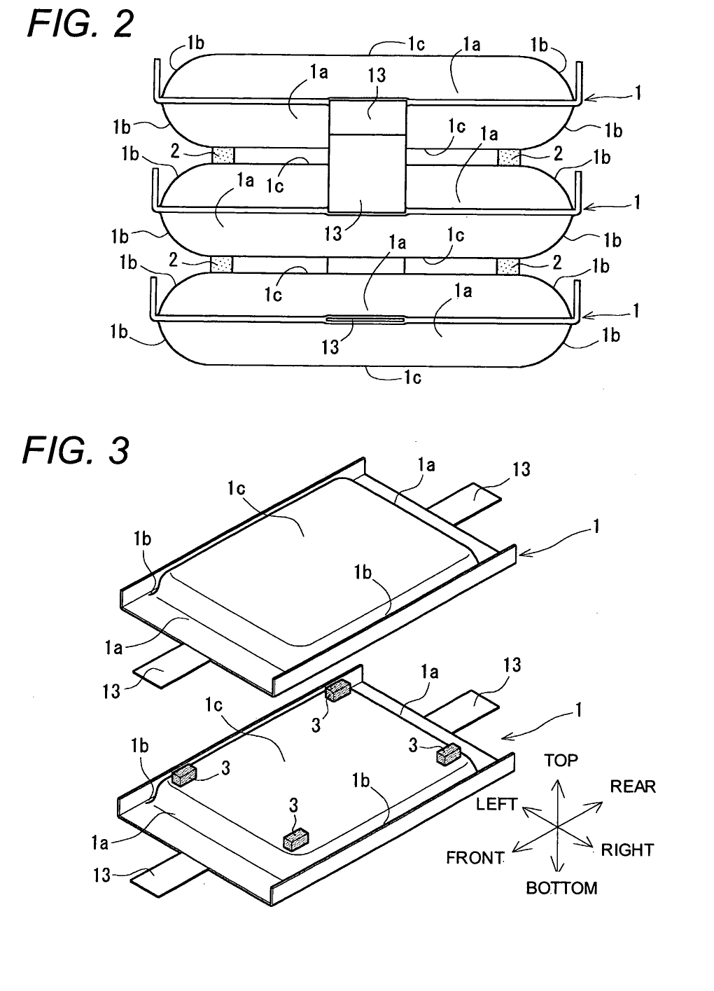

As shown in FIG. 1 and FIG. 2, Example 1 shows the case that rod-form spacers 2 are disposed between opposed flat faces 1c of vertically stacked neighboring nonaqueous electrolyte secondary cells 1 (Example of the second invention). These spacers 2 were in a square rod form with almost same length as the distance of the flat faces 1c of the nonaqueous electrolyte secondary cells 1 in the front and rear direction and arranged in the right and left end parts of the opposed flat faces 1c while the longitudinal directions were in the front and rear directions. The respective spacers 2 may be composed of hard resin-molded products; however, they are preferably composed of elastic bodies of a rubber, or the like. Further, the respective spacers 2 are preferable to be stuck to the flat faces 1c by using a both-sided adhesive tape or an adhesive so as not to be displaced easily.

In the nonaqueous electrolyte secondary cells 1 shown in Example 1, the right and left side end parts 1b to which the aluminum laminate films 11 were fusion-bonded parts were folded upward to narrow the width in the right and left directions of the assembled battery; however, nonaqueous electrolyte secondary cells 1 of which the side end parts 1b are not folded may be also allowed.

According to Example 1, since the spacers 2 were disposed between the opposed flat faces 1c of the neighboring nonaqueous electrolyte secondary cells 1, a gap can be reliably kept between the flat faces 1c. Moreover, since two spacers 2 were disposed in both end parts in the right and left directions of the gap between the wide flat faces 1c, air in the front and rear direction could be circulated almost entirely in the region of the gap between the flat faces 1c. Accordingly, heat release of the respective nonaqueous electrolyte secondary cells 1 could be promoted and the temperature difference between the nonaqueous electrolyte secondary cells 1 stacked in the upper and lower end parts and the nonaqueous electrolyte secondary cells 1 stacked in the center could be lessened. Further, in the case of using the spacers 2 of elastic bodies, high buffering effect on vibrations and impacts from outside can be exerted.

With respect to the assembled battery of Example 1 and a conventional assembled battery formed by stacking the nonaqueous electrolyte secondary cells 1 by sticking the flat faces 1c by a both-sided adhesive tape, the temperature of the respective nonaqueous electrolyte secondary cells 1 was measured at the time of continuous charge-discharge cycles. As a result, the maximum temperature difference among the cells was 8° C. in the case of the conventional example, whereas the maximum temperature difference among the cells was able to be suppressed to 3° C. in the case of Example 1. That is, it was confirmed that the temperature distribution among the respective nonaqueous electrolyte secondary cells 1 could be narrowed.

Further, a vibration test (JIS C8711) was carried out for the assembled battery of Example 1 using a rubber for the spacers 2 and the assembled battery of the conventional example. As a result, in the case of the conventional example, a trouble that aluminum laminate films 11 of the nonaqueous electrolyte secondary cells 1 were cracked occurred, whereas in the case of Example 1, such a trouble was not found and accordingly, it was confirmed that damages of the aluminum laminate films 11 could be prevented.

Although Example 1 shows the case two spacers 2 were disposed in the right and left end parts of the gap between the flat faces 1c; however, one or more spacers 2 may be added between these spacers 2 to reinforce the support of the neighboring nonaqueous electrolyte secondary cells 1. Further, these spacers 2 can be set along the right and left directions in place of the front and rear direction or along a diagonal direction.

Further, in place of the rod-form spacers 2, as shown in FIG. 3, four block-form spacers 3 may be positioned at the four corners of the gap between the flat faces 1c. In this case, not only the region of the gap between the flat faces 1c which is occupied by the spacers 3 is lessened but also air can be circulated in the front and rear direction as well as in the right and left directions of the gap between the flat faces 1c, so that the heat release efficiency of the nonaqueous electrolyte secondary cells 1 can be heightened. Moreover, with respect to the block-form spacers 3, the positioning arrangement and the number of the spacers to be arranged can also be changed arbitrarily.

### Example 2

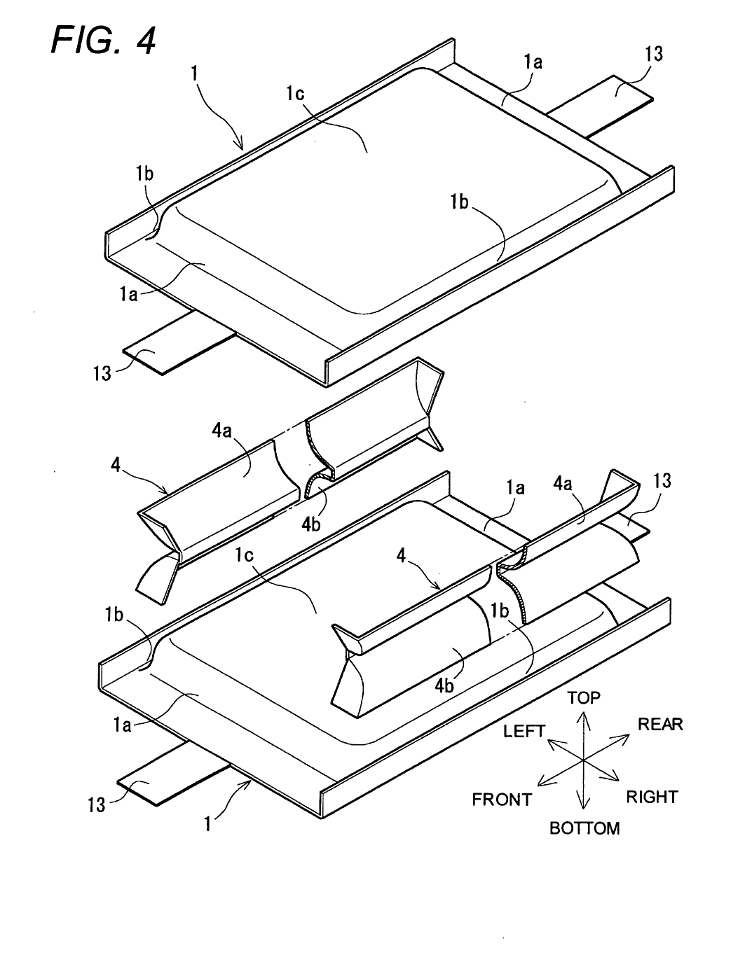

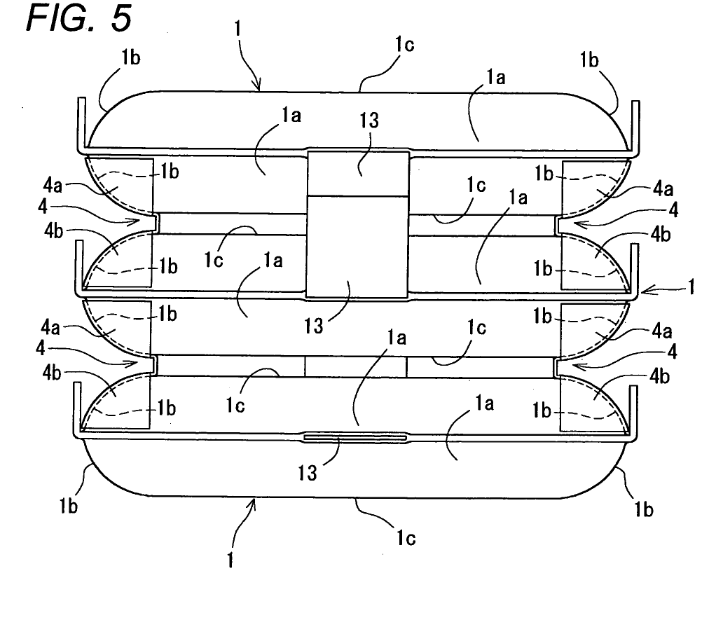

As shown in FIG. 4 and FIG. 5, Example 2 shows the case that frame-form spacers 4 are disposed between opposed side end parts 1b of vertically stacked neighboring nonaqueous electrolyte secondary cells 1 (Example of the third invention). These frame-form spacers 4 were used each in the right side end parts 1b and in the left side end parts 1b. These respective spacers 4 are frame bodies of resin thin sheets made by resin molding and each composed of an upper support part 4a and a lower support part 4b. The upper support part 4a is a part formed by curving a resin thin sheet in the recessed state so as to support one side end part 1b facing downward and the end parts 1a in its front and rear side of the upward neighboring nonaqueous electrolyte secondary cells 1. The lower support part 4b is a part formed by curving a resin thin sheet in the recessed state so as to support one side end part 1b facing upward and the end parts 1a in its front and rear side of the downward neighboring nonaqueous electrolyte secondary cells 1. These upper support parts 4a and the lower support part 4b are continued up and down at a slight gap.

Additionally, in the nonaqueous electrolyte secondary cells 1 shown in Example 2, the right and left side end parts 1b where the aluminum laminate films 11 were fusion-bonded parts were also folded upward to narrow the width in the right and left directions of the assembled battery; however, nonaqueous electrolyte secondary cells 1 of which the side end parts 1b are not folded may be allowed.

According to Example 2, since each one of the spacers 4 was disposed in right and left between the opposed side end parts 1b of the neighboring nonaqueous electrolyte secondary cells 1, a gap with a very side surface area can be reliably kept between the flat faces 1c. At maximum, air in the front and rear direction could be circulated entirely in the region of the gap between the flat faces 1c. Accordingly, heat release of the respective nonaqueous electrolyte secondary cells 1 can be promoted and the temperature difference between the nonaqueous electrolyte secondary cells 1 stacked in the upper and lower end parts and the nonaqueous electrolyte secondary cells 1 stacked in the center can be decreased. Further, since the spacers 4 of the frame bodies made of resin have spring elasticity, high buffering effect on vibrations and impacts from outside can be exerted. Moreover, these spacers 4 can prevent the displacement of the stacked nonaqueous electrolyte secondary cells 1 by the upper support part 4a and the lower support part 4b in the case where vibrations and impacts were caused particularly in the front, rear, right and left directions. According, damages of the aluminum laminate films 11 due to strong tensile force are suppressed.

With respect to the assembled battery of Example 2 and a conventional assembled battery formed by stacking the nonaqueous electrolyte secondary cells 1 by sticking the flat faces 1c by a both-sided adhesive tape, the temperature of the respective nonaqueous electrolyte secondary cells 1 was measured at the time of continuous charge-discharge cycles. As a result, the maximum temperature difference among the cells was 8° C. in the case of a conventional example, whereas the maximum temperature difference among the cells was suppressed to 3° C. in the case of Example 2. That is, it was confirmed that the temperature distribution among the respective nonaqueous electrolyte secondary cells 1 could be narrowed.

### Example 3

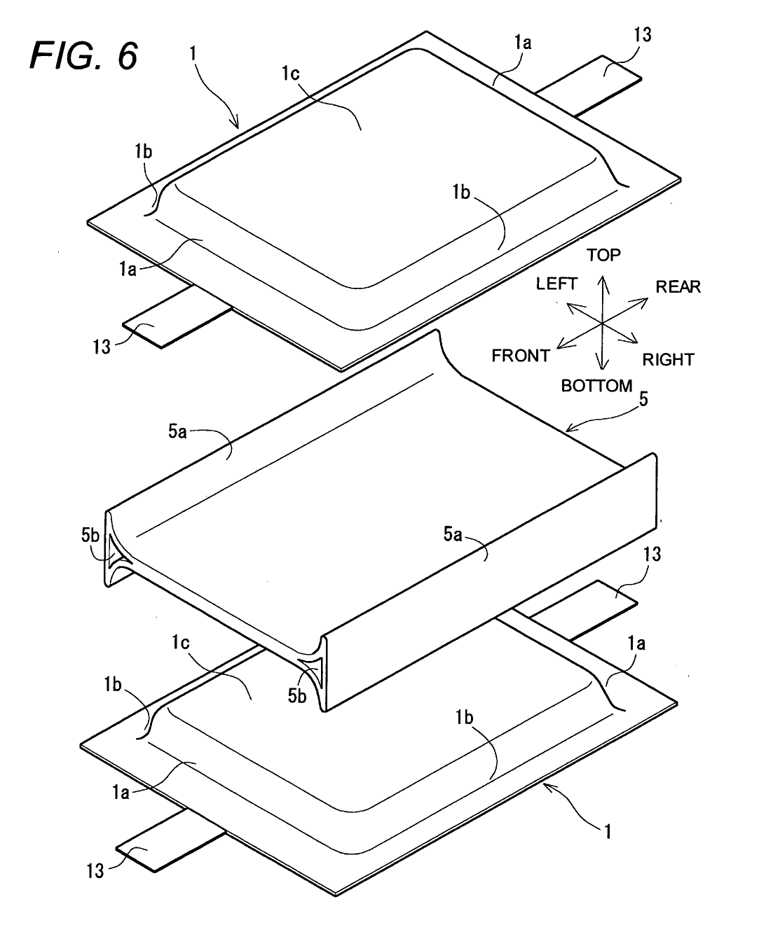

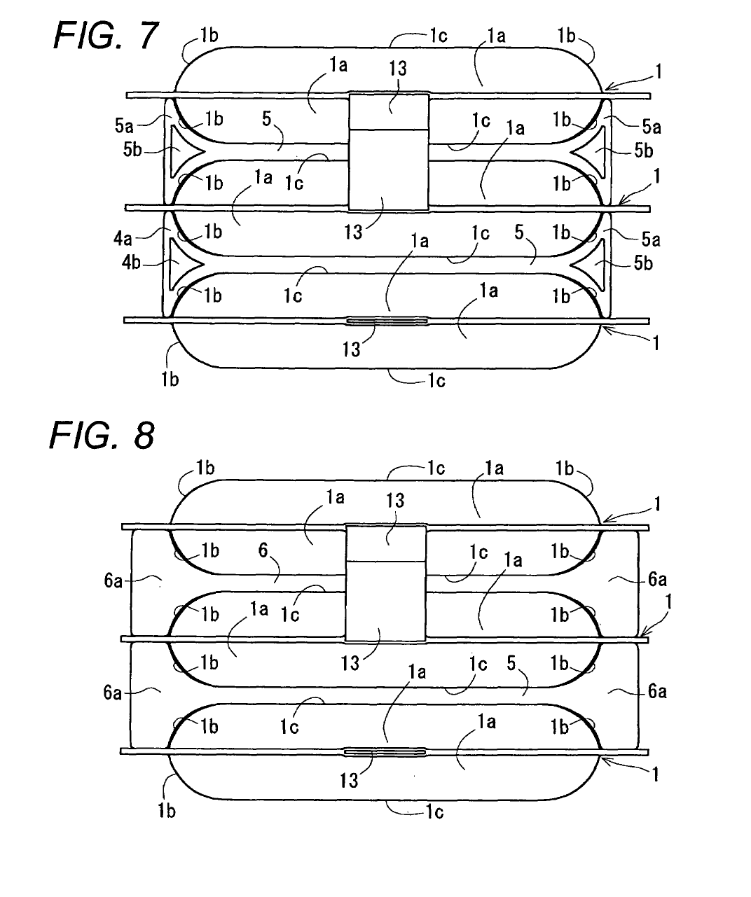

As shown in FIG. 6 and FIG. 7, Example 3 shows the case that spacers 5 are disposed all between opposed flat faces 1c and between opposed side end parts 1b (in both right and left sides) of vertically stacked neighboring nonaqueous electrolyte secondary cells 1 (Example of the fourth invention according to the present invention). These spacers 5 were plate form produced by resin molding and have each cell support parts 5a in both right and left end parts. The cell support parts 5a were parts of both end parts of each spacer 5 projected in the up and down direction.

The cell support parts 5a were formed while being curved in a recessed state to support the side end parts 1b of the vertically opposed nonaqueous electrolyte secondary cells 1. Further, triangular triangle holes 5b penetrating the cell support parts 5a in the front and rear direction are formed. In addition, although the right and left side end parts 1b were not folded in the nonaqueous electrolyte secondary cells 1 of Example 3, the spacers may be employed for the nonaqueous electrolyte secondary cells 1 in which the part of the side end parts 1b where the aluminum laminate films 11 were fusion-bonded are folded upward to narrow the width in the right and left directions of an assembled battery.

According to Example 3, since spacers 5 composed of solid bodies filled with a resin, were disposed between the opposed flat faces 1c of the neighboring nonaqueous electrolyte secondary cells 1 and the right and left side end parts 1b were also reliably supported by the cell support parts 5a of the spacers. Accordingly, displacement of the stacked nonaqueous electrolyte secondary cells 1 because of vibrations and impacts from the outside could be prevented and the probability of disconnection of the lead terminals 13 could be lowered.

Moreover, since triangle holes 5b were formed in the right and left cell support parts 5a of the spacers 5, a buffering effect can be exerted also owing to the elasticity of the parts with the thinned thickness. Further, air circulation can be promoted through the triangle holes 5b, so that heat release of the respective nonaqueous electrolyte secondary cells 1 can be promoted.

With respect to the assembled battery of Example 3 and a conventional assembled battery formed by stacking the nonaqueous electrolyte secondary cells 1 by sticking the flat faces 1c by a both-sided adhesive tape, a dropping test from 10 m height was carried out. As a result, the lead terminals 13 were sometimes disconnected in the case of the conventional example, whereas disconnection of the lead terminals 13 was not caused in Example 3 and thus the buffering effect by the spacers 5 was confirmed.

Although the case that the triangle holes 5b were formed in the cell support parts 5a of the spacers 5 was shown in Example 3, the entire spacers 5 may be formed to be solid bodies without the triangle holes 5b. However, if there are the triangle holes 5b, the cell support parts 5a can be made thin in the thickness and are provided with elasticity and therefore, the buffering effect as described above can be exerted. Further, in the case where the spacers 5 are elastic bodies made of a rubber or the like, the buffering effect can be exerted similarly.

As shown in FIG. 8, if spacers 6 are formed while cell support parts 6a are expanded outside in the right and left directions, the nonaqueous electrolyte secondary cells 1 can be supported by the cell support parts 6a even to the parts where the aluminum laminate films 11 are thermally fusion-bonded in the outer rim sides of the right and left side end parts 1b. Accordingly, the displacement of the nonaqueous electrolyte secondary cells 1 can be reliably prevented.

Further, although being not illustrated, in the case of providing a groove extended in the front and rear direction in the flat faces of the spacers, air flow channel can be formed between the flat faces, and therefore, an excellent heat release effect can be obtained.

In the cell support parts 6a of the spacers 6 shown in FIG. 6 to FIG. 8, only slight R is formed in the upper and lower edge parts; however, if the curvature of the R in the edge parts is further increased, the probability of damaging the aluminum laminate films 11 can more be reliably suppressed.

### Example 4

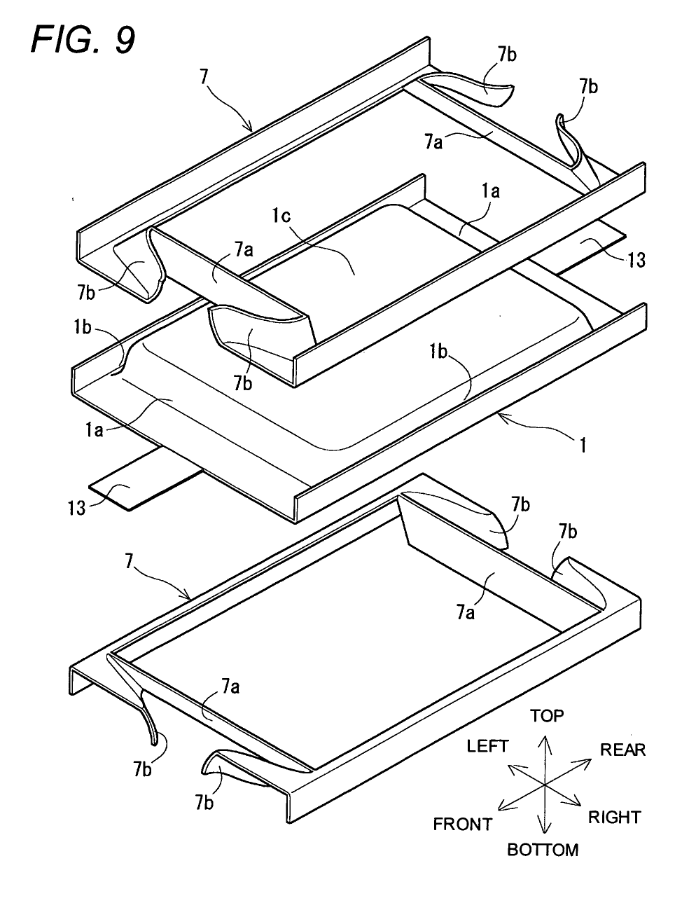

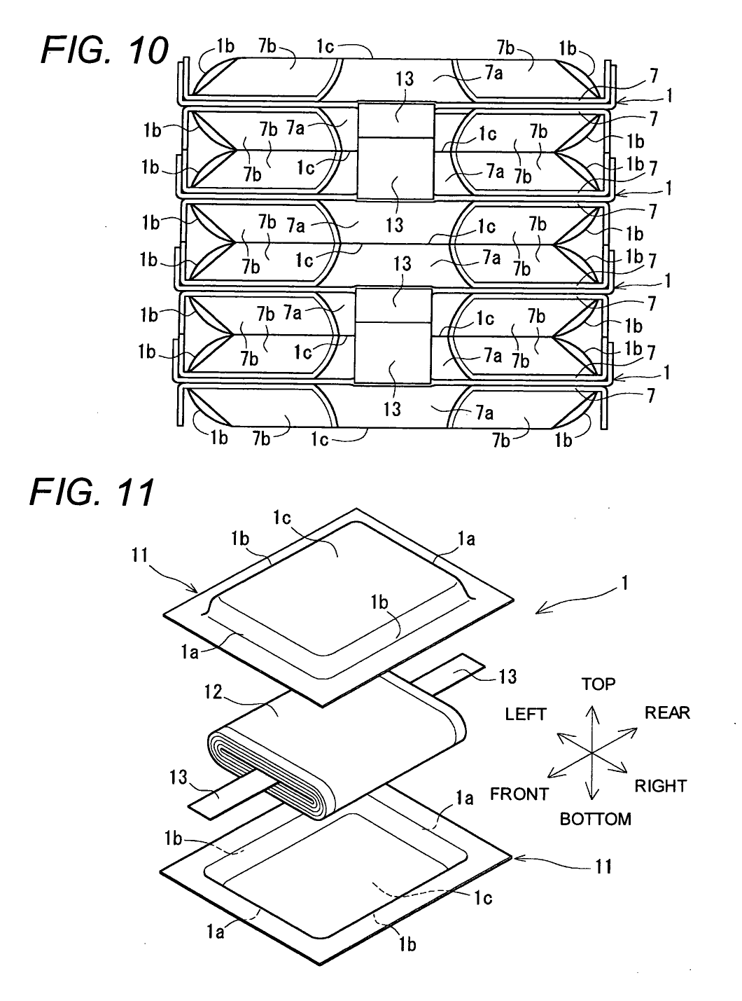

As shown in FIG. 9 and FIG. 10, Example 4 shows the case that a pair of frame body-form spacers 7 are disposed for supporting the front and rear end parts and the right and left side end parts of the neighboring nonaqueous electrolyte secondary cells 1 (Example of the fifth invention). These spacers 7 were square frame-form frame bodies of a resin thin sheet produced by resin molding. In the case where the spacers were fitted from the upper and lower sides of the nonaqueous electrolyte secondary cells 1, the projections of the flat faces 1c of the nonaqueous electrolyte secondary cells 1 were fitted in the punched hole parts in the center. The front, rear, right and left frame parts were brought into contact with the parts where the aluminum laminate films 11 were thermally fusion-bonded in the front and rear end parts and the right and left end parts of the nonaqueous electrolyte secondary cells 1.

The end support parts 7a and guide plates 7b are formed in the front and rear frame parts of these spacers 7. The end support parts 7a are resin thin sheet parts projected upward or downward while facing slantingly inward from the inner side ends of the front and rear frame parts of the spacers 7 and when the projected parts of the flat faces 1c of the nonaqueous electrolyte secondary cells 1 are fitted in the punched hole parts in the center, they were to be set along the inclination of the front and rear end parts 1a. The guide plates 7b are resin thin sheet parts projected outward in the front and rear direction from both right and left ends of the end support parts 7a and thus have slantingly curved faces closer to the center in the right and left directions as they are further outer sides in the front and rear direction.

A plurality of the respective nonaqueous electrolyte secondary cells 1 are stacked vertically while being fitted in a pair of spacers 7 from upper and lower sides to give an assembled battery. In this case, the flat faces 1c of the opposed nonaqueous electrolyte secondary cells 1 are kept very close to each other, that is, these flat faces 1c are set extremely closely or brought into contact with each other.

Herein, two spacers 7 disposed in the upper and lower sides of each nonaqueous electrolyte secondary cell 1 were explained as one pair. However, in the case where a plurality of the nonaqueous electrolyte secondary cells 1 were stacked, a lower side one of the pair of the spacers 7 for the upper side nonaqueous electrolyte secondary cell 1 and an upper side one of the pair of the spacers 7 for the lower side nonaqueous electrolyte secondary cell 1 formed a pair and are disposed between two neighboring nonaqueous electrolyte secondary cells 1.

In addition, with respect to the nonaqueous electrolyte secondary cells 1 shown in Example 4, the right and left width of the assembled battery is to be narrowed by upward folding the parts where the aluminum laminate films 11 are thermally fusion-bonded in the right and left side end parts 1b; however, the nonaqueous electrolyte secondary cells 1 in which the side end parts 1b are not folded are also actualized. In this case, the right and left end parts of the spacers 7 may be folded up and down as in the case of Example 4 or may be left without being folded as they are to be horizontal along the side end parts 1b of the nonaqueous electrolyte secondary cells 1.

According to Example 4, since guide plates 7b of the spacers 7 lead the air in the gap between the end parts 1a of the nonaqueous electrolyte secondary cells 1 and promote the air circulation. Accordingly, heat release of the respective nonaqueous electrolyte secondary cells 1 is promoted to decrease the temperature difference between the nonaqueous electrolyte secondary cells 1 in the upper and lower end parts and the nonaqueous electrolyte secondary cells 1 stacked in the center part.

Further, since the spacers 7 of the frame bodies made of resin have elasticity (spring elasticity) and the end support part 7a supports the front and rear end parts 1a of the nonaqueous electrolyte secondary cells 1, the buffering effect can be exerted on vibrations and impacts from the outside. Moreover, since the opposed flat faces 1c of the neighboring nonaqueous electrolyte secondary cells 1 were set close, the height of the assembled battery does not become higher than that of a conventional one.

In comparison of volume of the assembled battery of Example 4 with those of the assembled batteries of Examples 1 to 3, it was confirmed that the volume of Example 4 was reduced by 20% as compared with those of Examples 1 to 3. Moreover, the heat release effect of the respective nonaqueous electrolyte secondary cells 1 was not considerably deteriorated.

The present application is based on the parent application (Japanese Patent Application No. 2006-193275) submitted on Jul. 13, 2006 and its contents are all incorporated into this specification as reference.

### INDUSTRIAL APPLICABILITY

As described above, the temperature distribution among cells of an assembled battery of the present invention can be narrowed and the cells are hardly damaged even if the assembled battery receives impacts, and therefore, it is apparent that the assembled battery has industrial applicability.

1. An assembled battery comprising a plurality of flat cells having battery containers using flexible film and vertically stacked by opposing the flat faces to one another, wherein spacers are disposed between neighboring said cells.

2. The assembled battery according to claim 1, wherein said spacers are each composed of two or more parts arranged at interval to keep gaps between the flat faces of said neighboring cells.

3. The assembled battery according to claim 1, wherein said spacers are each composed of parts for supporting side end parts in the right and left of said cells so as to keep gaps between the flat faces of said neighboring cells.

4. The assembled battery according to claim 1, wherein said spacers are parts to be arranged from the left side end parts to flat faces of said neighboring cells and further to the right side end parts and have a thickness thicker between said left side end parts and between said right side end parts than between said flat faces.

5. The assembled battery according to claim 1, wherein said spacers are each provided with guide parts in at least one position of the front and the rear of said neighboring cells for inducing air blow and said guide parts are formed so as to induce air blow along the side end parts of said cells.

6. The assembled battery according to claim 4, wherein said spacers each have holes between the left side end parts and/or between the right side end parts of said neighboring cells.

7. The assembled battery according to claim 6, wherein the holes penetrate said spacers in the front and rear direction.

8. The assembled battery according to claim 1, wherein said spacers are elastic bodies.

9. The assembled battery according to claim 8, wherein said spacers are elastic bodies having rubber elasticity and spring elasticity.

10. The assembled battery according to claim 1, wherein said spacers each contain at least a shockproof material for buffering an impact from the outside and a material having higher heat conductivity than that of said shockproof material.

11. The assembled battery according to claim 10, wherein said material having higher heat conductivity contains at least one material selected from the group consisting of carbon and metals.
